(19) United States
(12) Patent Application Publication
(10) Pub. No.: US 2006/0203277 A1
(43) Pub. Date: Sep. 14, 2006

(54) Accounting device, accounting method and accounting program

(75) Inventor: Yuusuke Suzuki, Mishima-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/076,186

(22) Filed: Mar. 10, 2005

(51) Int. Cl. G06K 15/00

(52) U.S. Cl. 358/1.14

(57) ABSTRACT

The present invention provides an accounting device, an accounting method and an accounting program that can realize appropriate color accounting for image forming processing. The accounting device judges accounting for image forming processing, and includes a use amount estimation unit that estimates a use amount of color toner of a job which performs image forming processing, and an accounting judgment unit that determines color accounting in case the color toner use amount estimated by the use amount estimation unit exceeds a predetermined threshold value.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### RELATED APPLICATION INFORMATION

This patent is related to an accounting device, an accounting method and an accounting program, which are incorporated herein by reference.

### BACKGROUND OF THE INVENTION

1. Field of the Invention

The present invention relates to an accounting device, an accounting method and an accounting program.

2. Description of the Related Art

Conventionally, as a technique to perform accounting for image forming processing, there is known a technique that specifies a predicted consumption amount of toner corresponding to pixel area data of image forming data by referring to a corresponding related storage means, and specifies an image forming charge corresponding to thus specified predicted toner consumption amount by referring to a corresponding related storage means, and outputs thus specified image forming charge to an output means as a charge amount claimed of this time (Jpn. Pat. Appln. Laid-Open Publication No. 2003-76232).

However, under this technique, since the predicted toner consumption amount is calculated using pixel area data of image forming data, it is necessary to convert print data to a coordinate system of print resolution, raising a problem of bearing a heavy processing burden. Furthermore, even though contents of images are different concerning shading of colors, sizes of white background area in images, etc., in case sizes of images are equal to each other, accounting is imposed with the same charge.

In this way, in the past, it is difficult to appropriately reflect the difference of print contents on a predicted charge amount, which makes users feel unfair impression concerning the accounting.

It is therefore an object of the present invention to overcome the above-mentioned drawbacks by providing an accounting device, an accounting method and an accounting program that can realize appropriate color accounting for image forming processing.

### DESCRIPTION OF THE DRAWINGS

FIG. 1 is a block diagram for explaining an accounting device according to a first embodiment of the present invention.

FIG. 2 is a flow chart for explaining the flow of the processing of the accounting method (image forming processing concerning print processing, processing to perform accounting calculation) according to the present embodiment.

FIG. 3 is a diagram showing the relation between an estimated value of the color toner use amount and a predetermined threshold value.

FIG. 4 is a diagram for explaining the effect of the accounting device according to the present embodiment.

FIG. 5 is a diagram showing the relation between a predicted toner use amount including monochrome toner and a threshold value at the time of accounting judgment.

FIG. 6 is a diagram for explaining the case of calculating an estimated color toner use amount without weighting for respective colors and the case of carrying out weighting corresponding to color toner as is the case of the present embodiment.

FIG. 7 is a diagram for explaining a display list (intermediate code).

FIG. 8 shows a flow chart for explaining the estimation of toner use amount and accounting processing based on an intermediate code.

FIG. 9 is a diagram for explaining the specific example of an intermediate code and estimation of a toner use amount from the intermediate code.

FIG. 10 is an example of a correspondence table of frequency of appearance of characters to be depicted and the number of pixels to be used in obtaining a predicted toner use amount.

FIG. 11 is a flow chart for explaining the flow of accounting determination processing according to a sixth embodiment.

FIG. 12 is a diagram for explaining accounting determination processing for a print job of six pages.

FIG. 13 is a flow chart showing the flow of the processing in the accounting device according to a seventh embodiment.

FIG. 14 is a flow chart showing the flow of the processing in the accounting device according to the seventh embodiment.

FIG. 15 is an example of a UI in the present embodiment which is adapted to give notice to the user.

FIG. 16 is an example of image display on a display unit, not shown, of accounting amount notification and image forming method selection of an eighth embodiment.

FIG. 17 is a diagram showing the image forming processing method selection and accounting amount display on the object basis using a UI of a ninth embodiment.

FIG. 18 is a flow chart showing the flow of the processing in the accounting device according to the ninth embodiment.

FIG. 19 is a flow chart showing the flow of the processing in the accounting device according to the ninth embodiment.

FIG. 20 is a flow chart for explaining the flow of the processing in a tenth embodiment.

FIG. 21 is a flow chart for explaining the flow of the processing in the tenth embodiment.

FIG. 22 is an example of a user interface for use to make the user input the priority of changing image forming methods.

FIG. 23 is an example of a screen for setting up the condition of image forming method.

FIG. 24 is an example of a user interface for use to make the user select the image forming method for an object in a page.

### DETAILED DESCRIPTION OF THE INVENTION

Throughout this description, the embodiments and examples shown should be considered as exemplars, rather than limitations on the apparatus, methods and programs of the present invention.

### First Embodiment

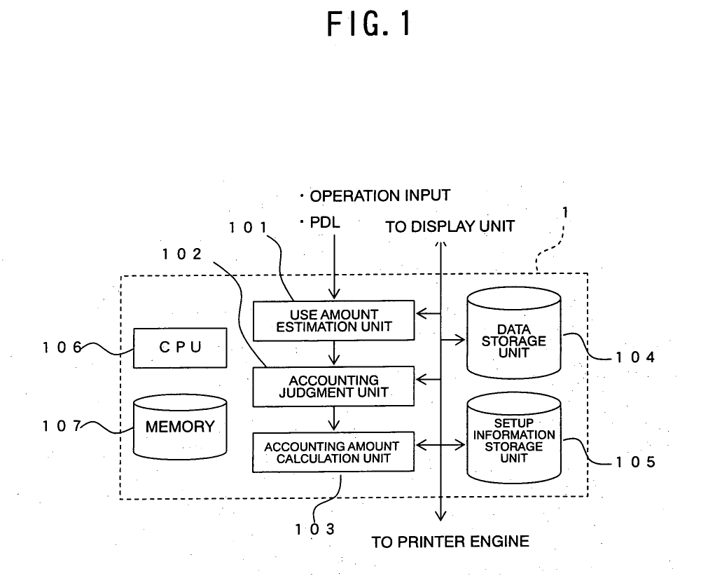

FIG. 1 is a block diagram for explaining an accounting device according to the first embodiment of the present invention.

An accounting device 1 of the present embodiment is arranged on, for example, a communication path between an apparatus (for example, a PC etc.) that receives an operation input from a user and an image forming apparatus that performs image forming processing. In this embodiment, description will be given for the case that the accounting device 1 is communicably connected to a PC and to an image forming apparatus through a network line such as a LAN.

In this embodiment, the accounting device 1 corresponds to a printer controller that manages processing in an image forming apparatus, to which configuration of the present invention is not restricted. That is, the accounting device 1 may be arranged in a PC or in an image forming apparatus, and any configuration can be employed so long as the function of the accounting device according to the present invention can be realized consequently. In this case, an apparatus provided with the accounting device according to the present invention can bring out the same effect as the accounting device. In this embodiment, in answer to a print requirement by a user, PDL data in which print contents are described in printer description language is generated to be transmitted to the accounting device 1. Image data to be printed out, through the accounting device 1, is transmitted to a printer engine to be output therefrom.

The accounting device 1 according to this embodiment includes a use amount estimation unit 101, an accounting judgment unit 102, an accounting amount calculation unit 103, a data storage unit 104, a setup information storage unit 105, a CPU 106, and a memory 107.

The use amount estimation unit 101 is provided with a function of estimating a use amount of color toner of a job that is to be transmitted to a printer engine to make an image forming apparatus carry out image forming processing. Specifically, the use amount estimation unit 101 estimates the color toner use amount based on at least the print resolution and the number of pixels of an area which is to be depicted using color toner with respect to the job.

The accounting judgment unit 102 is provided with a function of determining color accounting in case the color toner use amount estimated by the use amount estimation unit exceeds a predetermined threshold value.

The accounting amount calculation unit 103 is provided with a function of calculating an accounting amount in arbitrary image forming processing for a corresponding page based on the color toner use amount estimated by the use amount estimation unit. Furthermore, the accounting amount calculation unit 103 is also provided with a function of transmitting a print instruction based on a print setup that is set up in the accounting device 1 to a printer driver.

The data storage unit 104 may be an HDD etc., and is provided with a function of storing programs and the like to be carried out when image forming processing and accounting processing are performed. The data storage unit 104 has an area for spool secured therein so as to primarily store PDL data transmitted from an external apparatus such as a PC.

The setup information storage unit 105 may be an HDD etc., and is provided with a function of storing various setup information that is set up in the accounting device 1.

The CPU 106 is provided with a function of performing various processing in the accounting device 1, and is also provided with a function of realizing various functions by carrying out programs stored in the memory 107. The memory 107 may be a ROM or a RAM, and is provided with a function of storing various information, generated information, and programs which are utilized in the accounting device 1.

In this embodiment, the data storage unit 104 and the setup information storage unit 105 are included in the accounting device 1, to which configuration of the present invention is not restricted, and may be arranged in an external apparatus that is communicably connected to the accounting device 1.

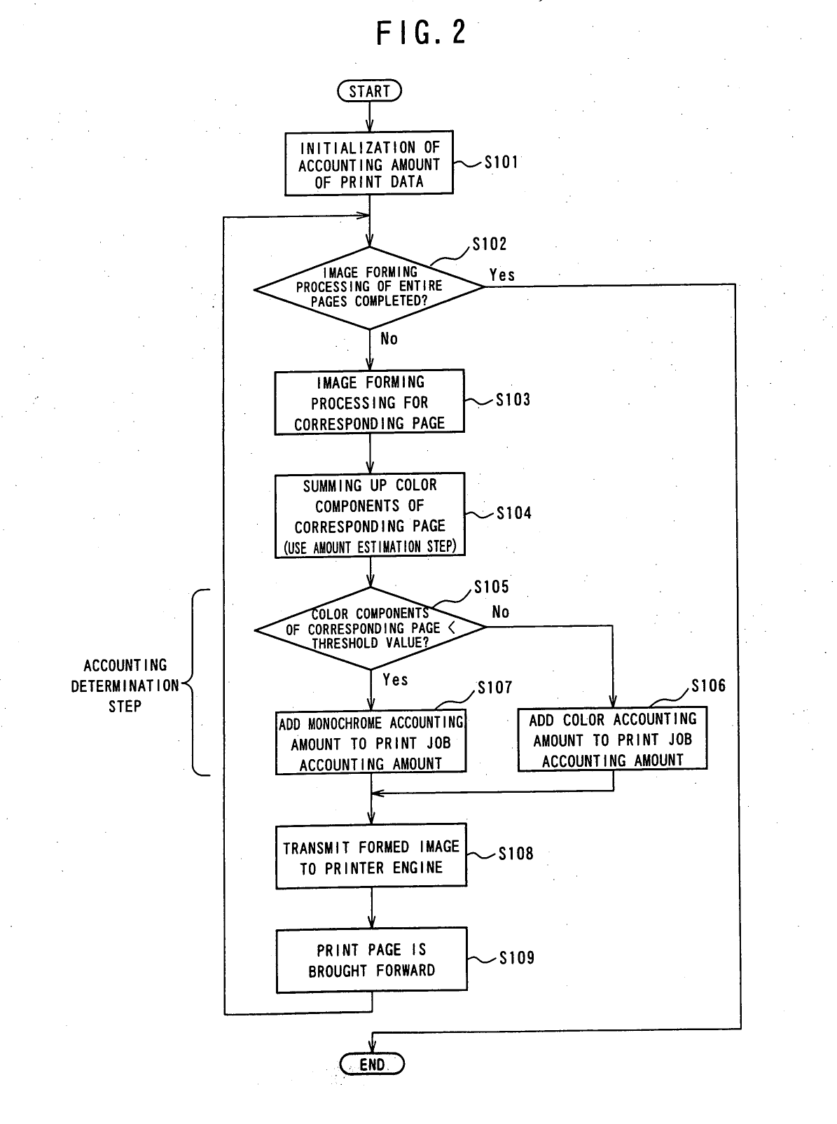

Next, an accounting method using the accounting device according to the present embodiment will be explained. FIG. 2 is a flow chart for explaining the flow of the processing of the accounting method (image forming processing concerning print processing, processing to perform accounting calculation) according to the present embodiment.

When the accounting device 1 receives PDL data to perform image forming processing, the PDL data is transiently stored in the data storage unit 104 or in the memory 107, and the processing of the flow chart shown in FIG. 2 is started.

Firstly, an accounting amount of print data is initialized (S101). Next, completion of print processing is judged for entire pages of print data (S102). In this processing, in case it is determined that accounting amount calculation processing for entire pages is completed (S102, Yes), accounting amount calculation for a print job is ended.

On the other hand, in case it is determined that accounting amount calculation is not completed (S102, No), accounting amount judgment processing is carried out on the page basis in accordance with a series of processing to be described later. Hereinafter, the case in which it is determined that the calculation is not completed in the judgment processing, and accounting amount judgment processing for pages is to be carried out will be explained. In this processing, image forming processing for images to be printed out is performed (S103).

Subsequently, as an estimated color toner use amount in accounting amount judgment, the use amount estimation unit 101 sums up color components of entire pixels of images to be printed out (S104) which are formed in the previous processing (S103). Specifically, the color toner use amount is estimated based on at least the print resolution and the number of pixels of an area which is to be depicted using color toner. In this processing, the number of summed up color components of the pixels is estimated to be the color toner use amount of a job that carries out image forming processing (use amount estimation step).

Then, the accounting judgment unit 102 compares the color toner use amount that is predicted (estimated) in the above-described processing with a previously set up predetermined threshold value (S105) to determine an accounting amount for a page (accounting determination step). In this processing, in case the estimated color toner use amount is higher than a predetermined threshold value, it is determined that color accounting is imposed.

In case the estimated color toner use amount is lower than the threshold value (S105, Yes), an accounting amount of a monochrome page is added to an accounting amount of print data (S107), while in case not (S105, No), an accounting amount of a color page is added to an accounting amount of print data (S106).

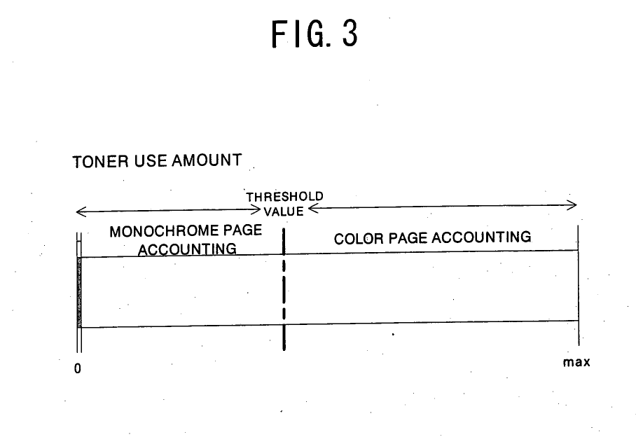

FIG. 3 is a diagram showing the relation between an estimated value of the color toner use amount and a predetermined threshold value. In FIG. 3, an estimated value of color toner use amount of a subject page to be printed out is lower than the threshold value, monochrome accounting is imposed on the subject page.

After adding an accounting amount of monochrome accounting or color accounting, image data to be printed out is transmitted to a printer engine to print out a corresponding page (S108), and one page of subject pages which will undergo accounting amount calculation processing and print processing is brought forward (S109), and the processing returns to the above-described entire page processing completion judgment processing for a print job (S102). Then, the above-described image forming processing and accounting determination processing are repeated until the processing for entire pages included in print data is completed. Accordingly, in case a job to be judged performs image forming processing of a plurality of pages, the accounting device 1 determines color accounting for the job on the page basis.

Note that, the above-described predetermined threshold value is registered in the setup information storage unit 105 in advance, and is registered by input operation (for example, input operation using a control panel of a PC or a printer) toward the accounting device 1 or by setup processing using programs for setup from an external apparatus through a network.

In this way, the accounting device according to the present embodiment calculates an estimated use amount of color toner of a page to be printed out, and imposes accounting by color accounting or monochrome accounting based on thus calculated estimated value. In FIG. 2, estimation of color toner use amount is carried out prior to image forming processing. Alternatively, however, the present invention is not restricted to this, and estimation of color toner use amount may be carried out after image forming processing.

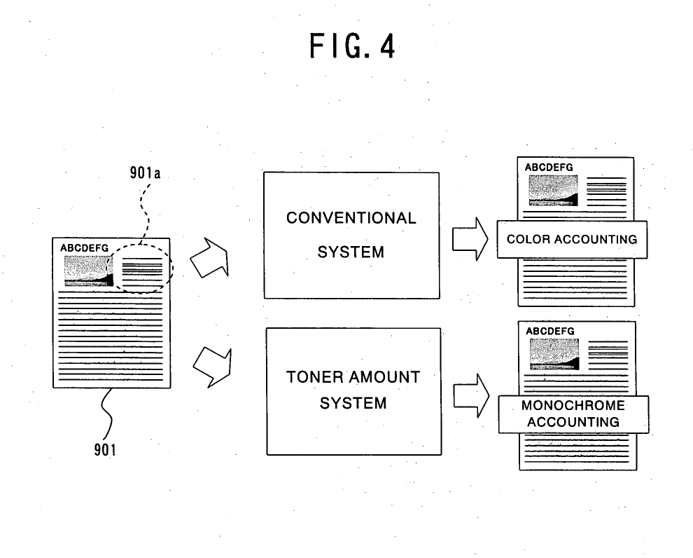

FIG. 4 shows a diagram for explaining the effect of the accounting device according to the present embodiment. In case of printing out a document 901 whose greater part in a page is configured by characters and pictures of achromatic color such as black and gray, and has red under lines 901a which are attached on small part of the characters for the purpose of highlighting, color toner is used to print out only the red under lines.

According to the conventional accounting method, even though color toner is used for such small part, this page is considered as a color page and color accounting is imposed. On the other hand, in the accounting method according to the present embodiment, in case estimated use amount of color toner is lower than a threshold value, accounting is imposed with monochrome accounting amount. Accordingly, even though color toner is used, since the color toner is used for small part, monochrome accounting is imposed on this page.

### Second Embodiment

Next, the second embodiment according to the present invention will be explained.

The second embodiment is a variation of the first embodiment, and as an estimated value of toner use amount to be used for accounting determination, the summation of entire toner components including monochrome toner is employed. Hereinafter, parts similar to those of the first embodiment are indicated with the same reference numerals, and detailed explanation of which will be omitted.

In the first embodiment, even if an estimated use amount of monochrome toner is small, in case an estimated use amount of color toner is higher than a threshold value if only slightly, color accounting is imposed on a subject page to be judged.

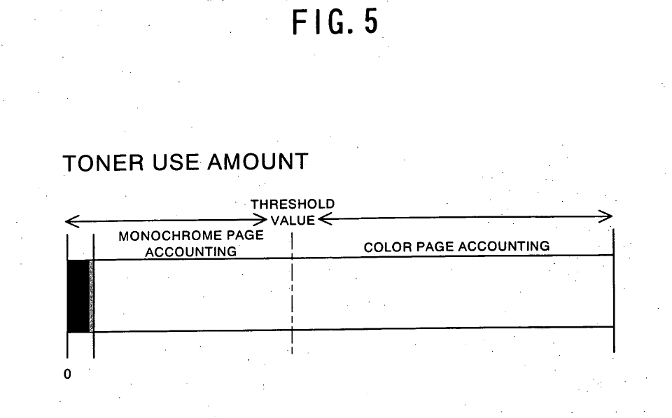

In the present embodiment, in the processing of summing up color components (S104) of the flow chart shown in FIG. 2, color components and monochrome components of pixels within a subject page to be judged are summed up, and in the accounting amount determination processing (S105), thus obtained summation value is compared with a threshold value (refer to FIG. 5).

In the present embodiment, since a threshold value used in the accounting determination is appropriately set up, in case of printing out a page in which area which is depicted using monochrome toner is small and whose estimated color toner use amount is slightly larger than the threshold value in the first embodiment, estimated toner use amount becomes smaller than a threshold value and print processing can be performed with an accounting amount of monochrome print, which can realize accounting that properly meets manuscript contents.

### Third Embodiment

Next, the third embodiment according to the present invention will be explained.

The third embodiment of the invention is a variation of the first embodiment, and when calculating an estimated use amount of color toner to be used for determination, estimated use amounts of color components of respective simple colors are not set to be the estimated value, but respective color components of toner are multiplied by coefficients for respective colors to be summed up, and accounting amount determination is performed using thus obtained summation value. Hereinafter, parts similar to those of the above-described embodiments are indicated with the same reference numerals, and detailed explanation of which will be omitted.

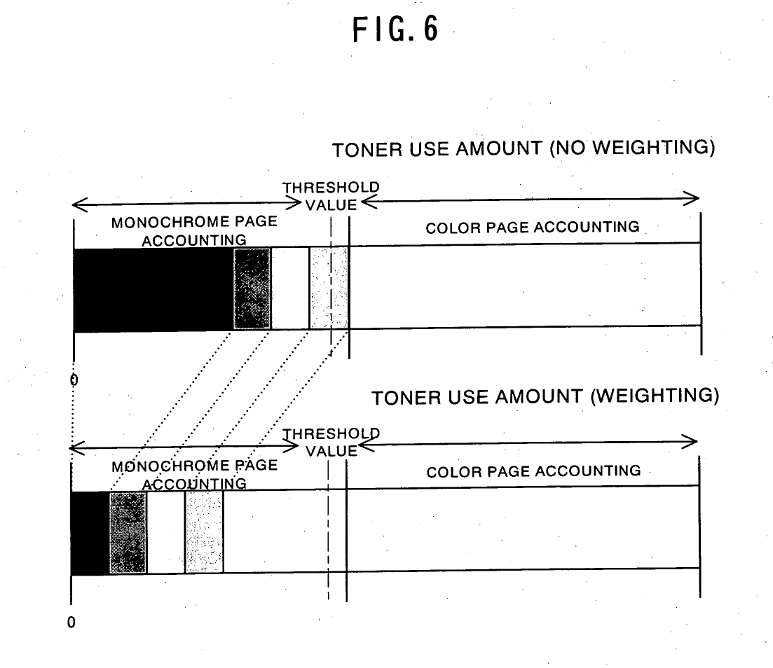

FIG. 6 is a diagram for explaining accounting amount determination processing using an estimated value in the case of calculating an estimated color toner use amount without weighting for respective colors, and that in the case of carrying out weighting corresponding to color toner as is the case of the present embodiment.

In this processing, it is assumed that the price of black toner is lower than that of color toner. When printing out a manuscript show in the example, in case weighting is not performed, since toner consumption amounts of respective colors are simply summed up, and thus obtained value is set to be an estimated value of the estimated toner use amount on which accounting is imposed, color accounting is imposed on this page (refer to the upper side of FIG. 6).

On the other hand, in the present embodiment, since weighting that reflects the difference of toner price is performed, there is calculated an estimated toner use amount that reflects the price of inexpensive monochrome toner and is lower as compared with the case shown in the upper side of FIG. 6 (refer to the lower side of FIG. 6), and thus monochrome accounting which is more inexpensive than color accounting is imposed on the subject page to be judged.

In this way, according to the third embodiment, in case prices of respective colors of toner are different from each other, weights corresponding to prices of respective colors are determined, and predicted toner consumption amounts of respective colors are multiplied by the respective weights, which makes it possible to impose accounting which is close to the charge amount of toner that is to be actually consumed.

### Fourth Embodiment

Next, the fourth embodiment according to the present invention will be explained.

The fourth embodiment is a variation of the first embodiment, and an estimated toner use amount is calculated using a display list (intermediate code) that is formed after PDL analysis. Hereinafter, parts similar to those of the above-described embodiments are indicated with the same reference numerals, and detailed explanation of which will be omitted.

In the present embodiment, image forming processing is not performed prior to calculation of an estimated value of toner use amount, as is different from the first embodiment, and the processing is suspended until analysis processing of PDL data and intermediate code generation processing following the PDL analysis processing. In the present embodiment, the use amount estimation unit estimates the color toner use amount based on a display list (information of depiction coordinate system that is specified by an intermediate code) generated corresponding to a job of image forming processing.

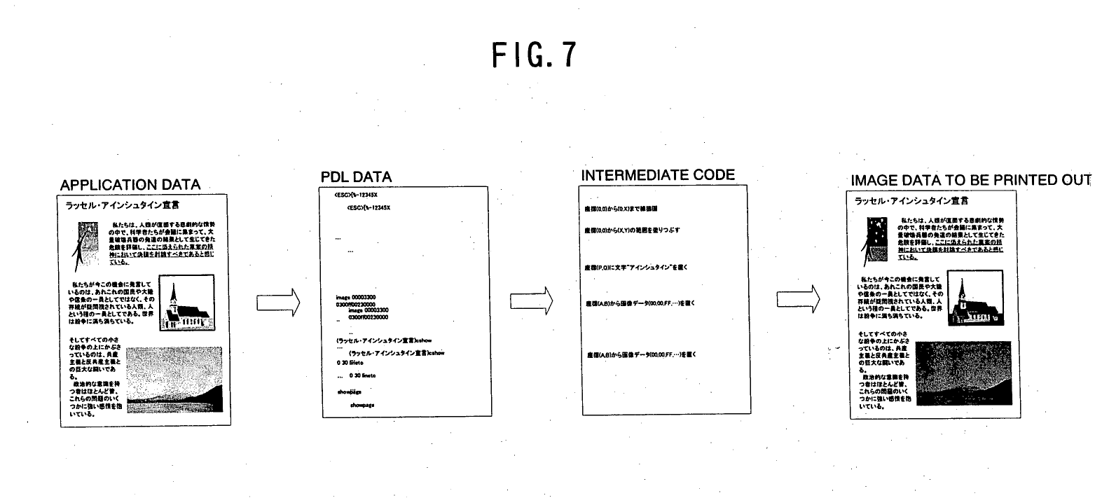

FIG. 7 is a diagram for explaining a display list (intermediate code). The intermediate code is data which is formed during print processing. In FIG. 7, application data is data dealt with by an application such as the word processor or spreadsheet that the user operates on a PC or the like. PDL data is generated by a printer driver, and is data described by a language of Page Description Language such as the PostScript, PCL, LIPS, or ESC/P. The intermediate code (display list) is data obtained by analyzing depiction contents of input PDL data. When depiction processing using the intermediate code is performed, a page can be easily partitioned into small units, which makes it possible to easily correspond to banding function that enables image forming processing with an image memory for a page or lower, and to expansion of a command supported by a language.

Image data to be printed out is image data that is rasterized based on information of the above-described intermediate code.

In this way, since toner amount is estimated based on a display list, the estimated value of toner use amount can be calculated, not by counting color components concerning pixels, but by the calculation processing based on coordinate information, which can reduce processing burden as compared with the case of counting color components, enabling fast calculation of the estimated value of toner use amount.

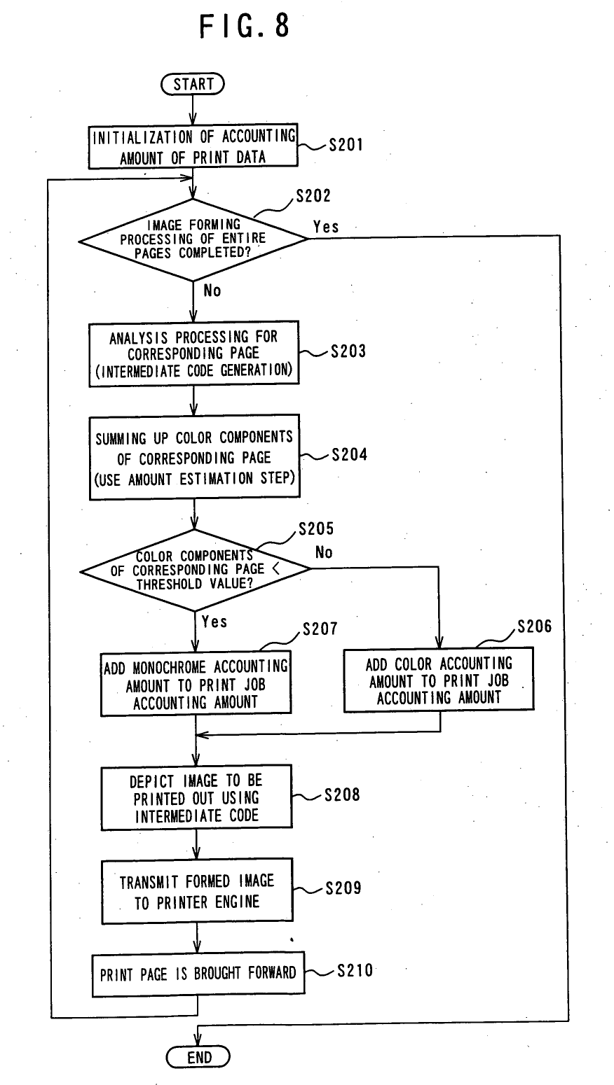

FIG. 8 shows a flow chart for explaining the estimation of toner use amount and accounting processing based on an intermediate code.

Firstly, similar to the first embodiment, processing from the initialization of an accounting amount of print data (S201) to the page analysis (intermediate code generation processing) (S203) being halfway processing of image forming processing are performed.

In the page analysis processing, high level depiction contents described in PDL data obtained by the use amount estimation unit 101 is analyzed, and an intermediate code (display list) that is a command to instruct simpler depiction is generated (S203). The intermediate code is composed of a coordinate of a device coordinate system of an image to be printed out, colors, and sorts of an object to be depicted.

Next, using thus generated intermediate code, color and size of a depiction object is calculated from information of sort of the intermediate code, shape of the object, expansion ratio, a coordinate to be arranged, and color, and thus calculated values are set to be the estimated value of color toner use amount of a corresponding page (color components counting processing) (S204).

Then, similar to the first embodiment, after the accounting determination and accounting processing using estimated toner use amount (S205 to S207), depiction processing for an image to be printed out is performed using an intermediate code generated in the former processing (S208). Then, thus depicted image is transmitted to a printer engine (S209), and the accounting judgment is performed for the next subject page (S210).

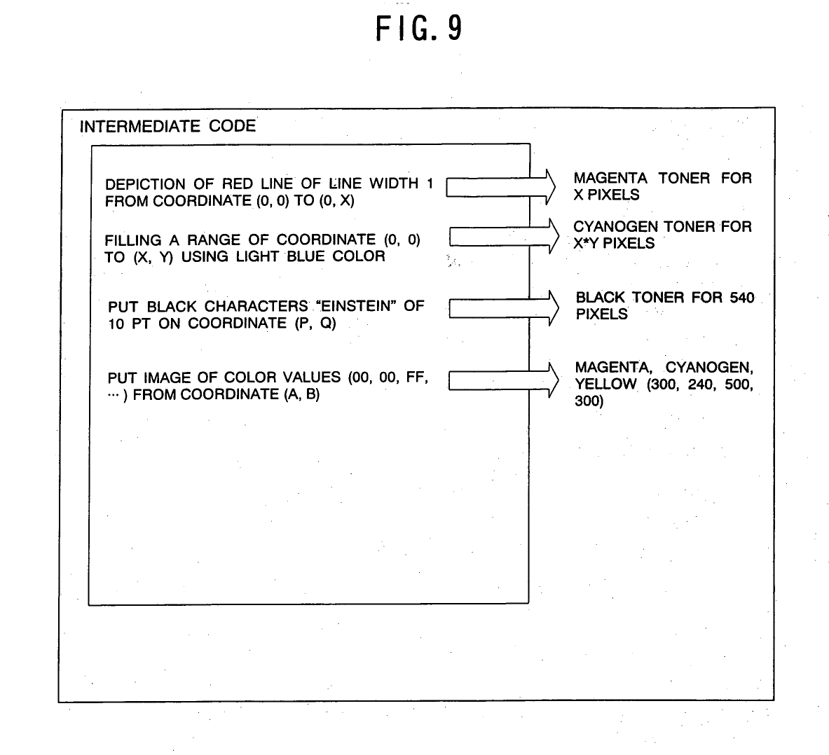

FIG. 9 is a diagram for explaining the specific example of an intermediate code and estimation of a toner use amount from the intermediate code. For example, an estimated magenta toner use amount for X pixels can be calculated from an intermediate code of making a red line of line width 1 from a coordinate (0, 0) to a coordinate (0, X). Furthermore, estimated cyanogen toner use amount for X*Y pixels can be calculated from an intermediate code of instructing the processing of filling a rectangle with opposing corner apexes of a coordinate (0, 0) and a coordinate (X, Y) using light blue color.

As for calculation of toner use amount for the intermediate code part depicting character font, the average number of pixels of font calculated in advance is multiplied by a number obtained by dividing the number of points to be depicted by the number of points of font at the time of calculating the average pixel number, and thus obtained value is multiplied by the number of characters to be depicted, and the resulting value is set to be the number of pixels to be depicted.

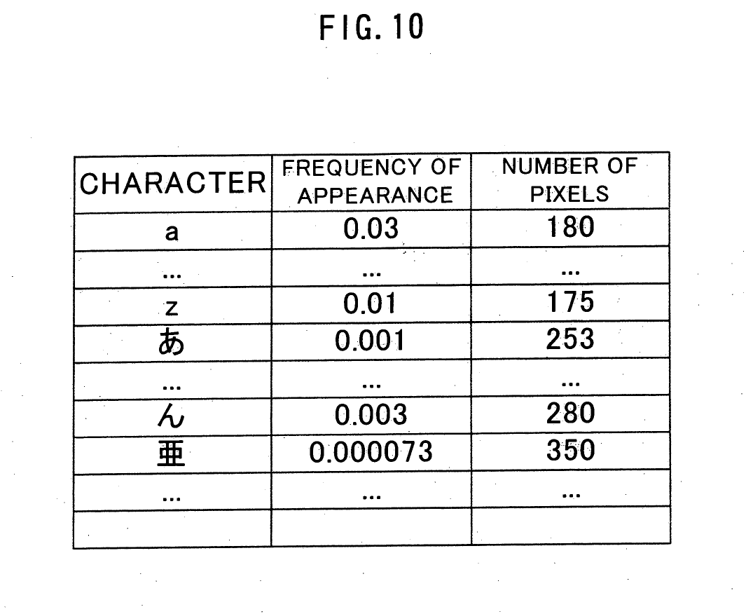

The average pixel number of font to be used in calculating estimated toner use amount of font is calculated in advance from the frequency of appearance of characters and the number of pixels to be depicted with the number of specified points shown in FIG. 10 prior to RIP (Raster Image Processor) processing. The appearance frequency of characters used in the calculation is a value statistically calculated, and is registered in the data storage unit 104 in advance.

The appearance frequency, which is not information that depends on font sort, is managed separately from font information, and is used for calculating the average pixel number of a plurality of font sorts. As for a font that is downloaded to a printer controller, the average pixel number is calculated after the font download, and is registered in an HDD together with the font data. When printing out with font definition which is not owned by a printer controller added to PDL data, the number of pixels to be depicted is calculated at the time of interpreting the font definition.

When calculating estimated toner use amount from an intermediate code that lays out an image, a previously counted value is used at the stage of analyzing PDL data and generating the intermediate code. Thus, the number of times of scanning image data can be reduced, and the processing can be carried out faster as compared with the case of simply scanning an image in an intermediate code. With the above-described processing, estimated toner use amount at the time of printing out pages is calculated from an intermediate code generated from PDL data.

In the present embodiment, the use amount estimation unit 101 obtains PDL data, and generates an intermediate code, to which the present embodiment is not restricted. For example, there may be employed an example in which generation of an intermediate code is performed at the upstream of the accounting device 1, and the use amount estimation unit 101 obtains thus generated intermediate code. That is, any configuration can be employed so long as toner use amount is estimated based on an intermediate code (display list).

### Fifth Embodiment

Next, the fifth embodiment according to the present invention will be explained.

The fifth embodiment is a variation of the fourth embodiment, and at the time of calculating a predicted amount of an image object when calculating an estimated toner use amount from an intermediate code that depicts an image, the number of pixels of respective colors are not counted by scanning an image, but the number of pixels in a print coordinate system is calculated using the number of pixels included in an intermediate code and depiction magnification. Then, thus calculated value is multiplied by a coefficient, and setting the resulting value to be an estimated value of color toner use amount of an image area. Accordingly, the processing of scanning image data in PDL data which requires time can be realized by simple calculation processing, realizing faster accounting determination processing. Hereinafter, parts similar to those of the above-described embodiment are indicated with the same reference numerals, and detailed explanation of which will be omitted.

In PDL data, an image is described using an image depiction command. At the time of instructing image depiction, parameters concerning an image such as image width, height, and the number of bits in one pixel are set up. An image depiction command in PDL data is converted to an intermediate code that instructs image depiction, and parameters concerning an image such as image width, height, etc. are saved in the intermediate code at the time of the conversion.

At the time of calculating an estimated toner use amount, the image width and height are multiplied by a magnification when converted to a device coordinate system by the CTM (Current Transformation Matrix), and the number of pixels to be depicted of image data is calculated as (width×magnification along image width direction)×(height×magnification along image height direction), and an estimated value of the number of pixels to be depicted of respective colors is calculated by multiplying the number of pixels by a coefficient. The coefficient used here is switched depending on whether image data is data of color space such as RGB or CMYK corresponding to colors, or data of color space such as gray scale that cannot depict colors.

### Sixth Embodiment

Next, the sixth embodiment according to the present invention will be explained.

The sixth embodiment is a variation of the first embodiment, and the processing of accounting determination is carried out not on the page basis but on the job basis. Hereinafter, parts similar to those of the above-described embodiments are indicated with the same reference numerals, and detailed explanation of which will be omitted.

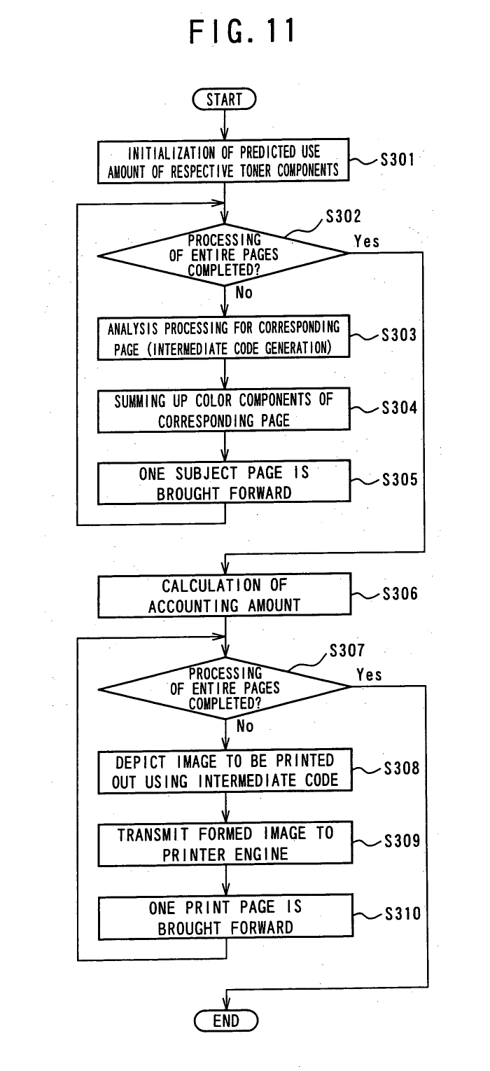

FIG. 11 is a flow chart for explaining the flow of accounting determination processing according to the present embodiment.

Firstly, an estimated toner use amount of respective colors concerning a print job is initialized (S301). Next, it is judged whether or not calculation of an estimated toner use amount is completed for entire pages of a print job (S302). In case it is determined that the processing for entire pages is completed (S302, Yes), the processing goes to the next step or the processing of calculating accounting amount, and in case not (S302, No), the processing goes to the processing of calculating estimated color toner use amount to be described next. In the estimated color toner use amount calculation processing, analysis processing for a corresponding page in PDL data obtained by the use amount estimation unit 101 is performed to generate an intermediate code (S303), and an estimated color toner use amount is calculated from thus generated intermediate code, and the obtained value is added to an estimated entire toner use amount of a job (S304), and one page of subject pages is brought forward (S305). These estimated amount calculation processing is continued until the processing for the entire pages of a print job is completed (use amount estimation step).

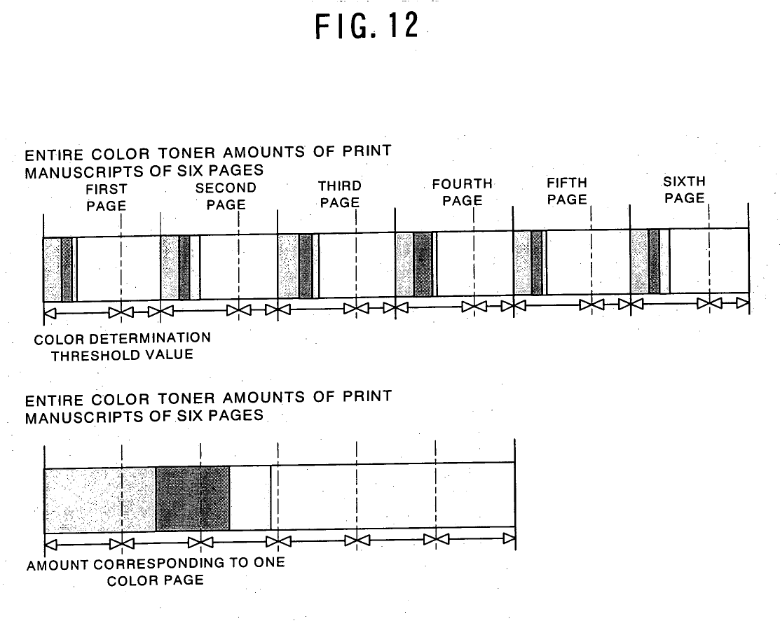

After the calculation of estimated toner use amount for the entire pages (color toner use amount of an entire job of image forming processing) is completed, the accounting amount calculation unit 103 calculates an accounting amount (S306). FIG. 12 is a diagram for explaining accounting determination processing for a print job of six pages. The upper side of FIG. 12 shows the relation between an amount of color toner included in respective pages of a print job and an example of a threshold value in the processing of the first embodiment. Dashed lines in FIG. 12 shows threshold values at the time of performing color/monochrome determination on the page basis. When performing accounting processing of a print job shown in the example, under the conventional method in which the existence of color components in a page alone is judged, it is determined that there are 6 color pages and no monochrome page. On the other hand, under the method of the first embodiment, it is determined that there are no color page and six monochrome pages.

In the present embodiment, the accounting judgment unit 102 divides a color toner use amount of an entire job of image forming processing estimated in the use amount estimation step by a predetermined toner amount corresponding to one color print page, and sets thus calculated quotient to be the number of pages subject to color accounting (accounting determination step).

In the accounting method according to the present embodiment, the toner amount of an entire print job is divided by a predetermined toner amount that determines one color page, and color accounting is imposed on pages, the number of which is equal to the resulting quotient, and monochrome accounting is imposed on other pages. The lower side of FIG. 12 shows the relation between the summation of estimated color toner use amounts included in six pages and threshold values (dashed lines) that perform determination processing in the present embodiment. In FIG. 12, since the summation of estimated color toner use amounts exceeds a color determination threshold value (a predetermined toner amount for determining one color page) for two pages and does not exceed that for three pages, accounting of two color pages and four monochrome pages is imposed on this print job. After the accounting amount calculation processing, an image is formed using an intermediate code which is formed to calculate estimated color toner use amounts (S308), and an image to be printed out formed in the image forming processing is transmitted to a printer engine to be printed out (S309), and one page of subject pages is brought forward one by one (S310), which processing is repeated until the processing for the entire pages in the print job is completed (S307).

In this way, by carrying out determination processing on the job basis, accounting determination can be performed using entire estimated toner use amounts of one print job, and in case of a job that prints out a plurality of pages and entire pages of which includes color pages which are determined to be monochrome pages in the first embodiment, since the summation of toner use amounts of an entire job is used for determination, accounting close to actual toner consumption can be realized.

### Seventh Embodiment

Next, the seventh embodiment according to the present invention will be explained. Hereinafter, parts similar to those of the above-described embodiments are indicated with the same reference numerals, and detailed explanation of which will be omitted.

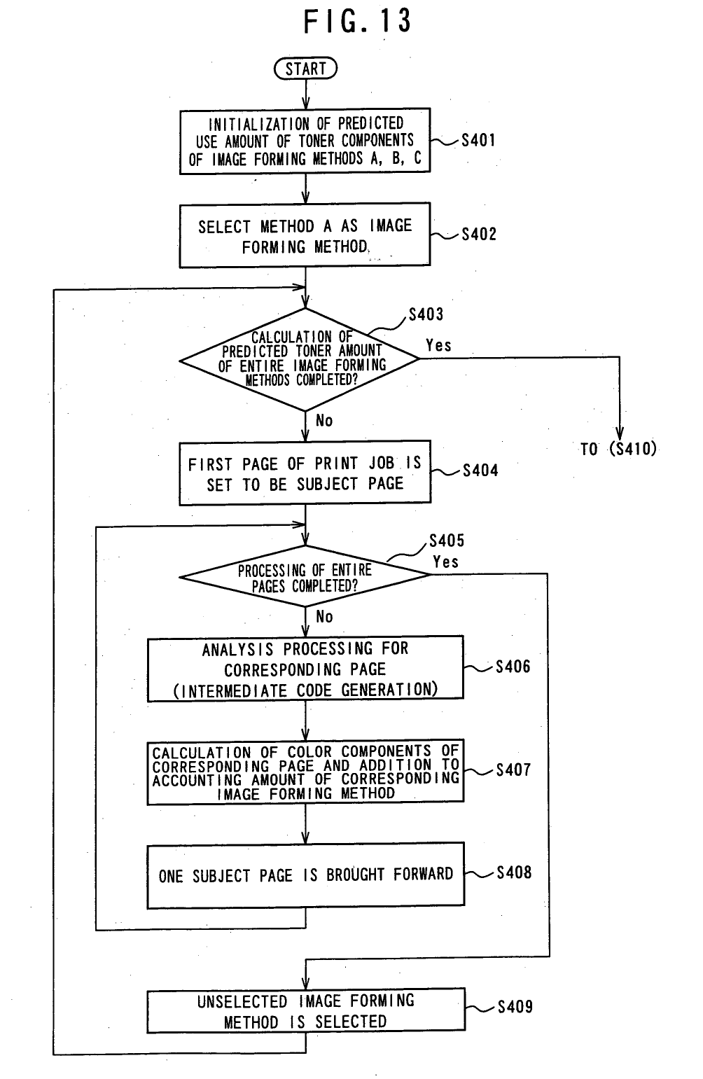

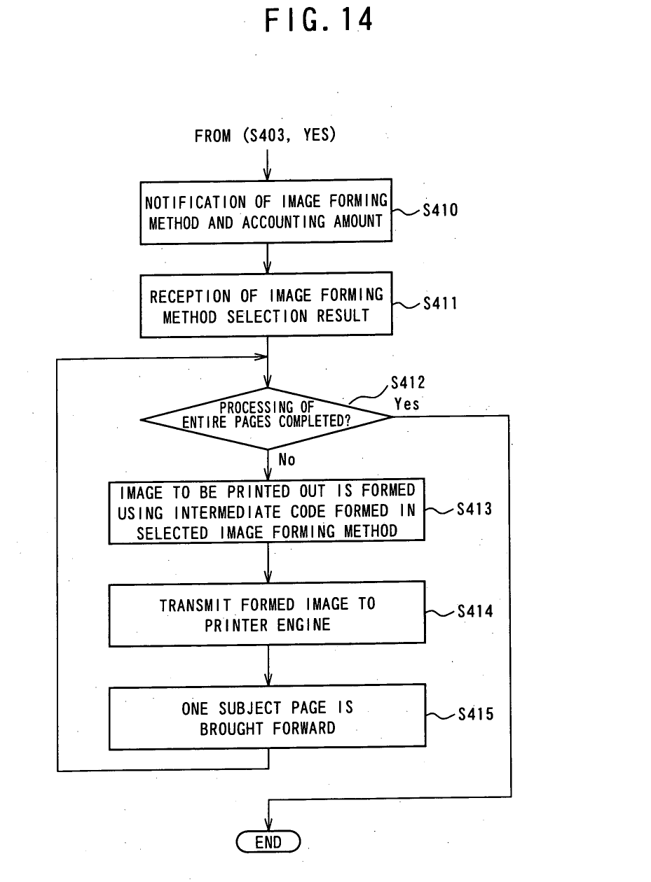

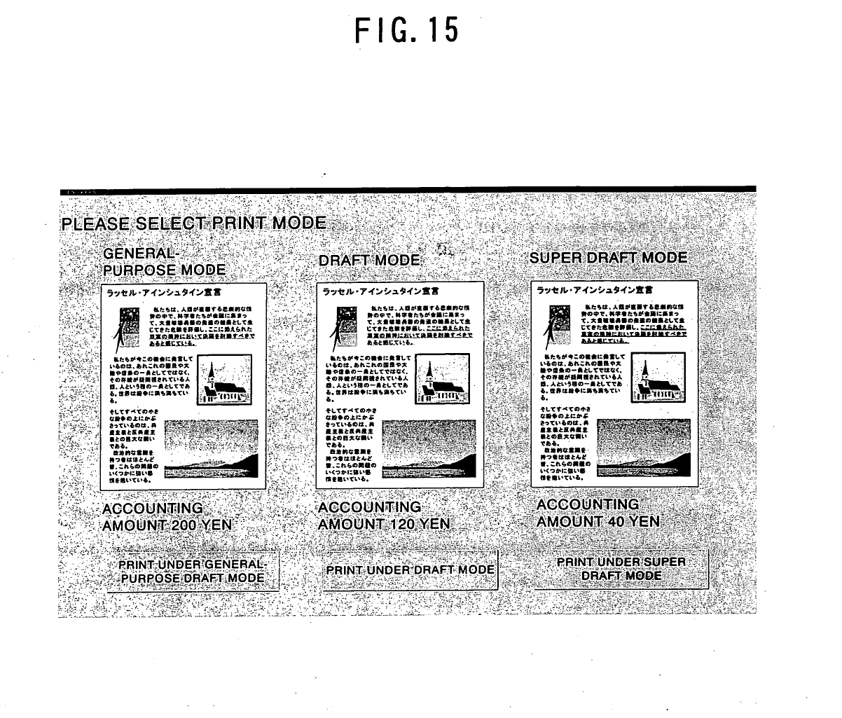

FIG. 13 and FIG. 14 are flow charts showing the flow of the processing in the accounting device according to the present embodiment, and FIG. 15 is an example of a UI in the present embodiment which is adapted to give notice to the user.

An accounting device according to the present embodiment is communicably connected to an image forming apparatus having three kinds of modes or a general-purpose mode using an image forming method that places great importance on appearance of a color document, a draft mode that performs image forming processing of printing out image parts being one of objects whose toner consumption amount is large in a color document using monochrome toner to suppress toner consumption, and a super draft mode that performs image forming processing of leaving highlighted parts by color being especially important text in documents and printing the other parts using gray scale to perform print processing with a smaller toner use amount as compared with the draft mode, or is arranged in the image forming apparatus.

Firstly, after the use amount estimation unit 101 obtains PDL data, variables used to store accounting amounts when performing print processing using the above-described three respective image forming methods are initialized (S401). Next, one of the above-described three image forming methods is selected (S402). So as to carry out processing using a plurality of image forming methods repeatedly, it is confirmed whether or not accounting calculation of all the image forming methods is completed (S403). In case the processing is completed (S403, Yes), the processing goes to the processing of giving notice of accounting amounts in case print processing is performed using the respective image forming methods. On the other hand, in case the processing is not completed (S403, No), the accounting amount calculation processing is repeated. It is assumed that the accounting amount calculation is not completed.

Firstly, the first page of PDL data is set to be the subject page (S404). Next, judgment processing for repeatedly processing the entire pages included in print PDL is performed. In this processing, it is confirmed whether or not the subject page for processing exceeds the last page included in print PDL (S405). In case the subject page exceeds the last page included in a print job, it is determined that processing for the entire pages is completed, and an unselected image forming processing method is selected (S409). On the other hand, in case the subject page does not exceed the last page and accounting amount determination is not completed for the entire pages, an intermediate code for the page is generated by carrying out PDL analysis processing (S406). Next, an estimated toner consumption value of the page is calculated using thus generated intermediate code (use amount estimation step) (S407), and the page is brought forward (S408). Then, the processing is returned to entire page processing completion confirmation processing (S405) to repeat accounting judgment processing for the entire pages of the print job (accounting amount calculation step). That is, the use amount estimation unit estimates the color toner use amount for respective image forming processing when performing image forming processing of plural kinds whose accounting amounts for pages in a job of image forming processing are different. Then, the accounting amount calculation unit calculates accounting amounts for the pages in respective image forming processing based on the color toner use amount estimated in the use amount estimation step.

With respect to all the image forming methods of the subject image forming apparatus, when accounting amount calculation processing for the print job is completed (S403, Yes), notification processing of notifying the image forming method to perform accounting amount calculation and the accounting amount of the print job calculated by respective methods is performed (S410), and reception of image forming processing selection result information based on the notification result is performed (S411).

FIG. 15 is an example of a UI image that displays the result of the above-described processing to the user to make the user select an image forming method. With the means shown in the FIG. 15, accounting amount is notified, and the user is made to select an image forming processing method for a print job, and print processing is carried out with an image forming method that is selected by operation input of the user.

When the accounting device according to the present embodiment receives the operation input concerning the selection of an image forming method from the user, since the entire print job is printed out based on the selection result, it is judged whether or not print processing is performed with the state exceeding the last page included in PDL data (S412). In this judgment, in case of exceeding the last page, print processing based on the selection information is completed with respect to entire pages included in PDL data (S412, Yes), ending the print processing.

In case not (S412, No), the print processing is considered to be in midstream, and print processing under the selected image forming processing is carried on. Hereinafter, the case in which the processing is not completed will be explained. In case the processing is not completed (S412, No), image forming processing is performed using an intermediate code formed in the image forming processing in which the print page is selected (S413). Then, an image to be printed out that underwent the image forming processing is transmitted to a printer engine to be printed out (S414). Then, the print page is brought forward by one page (S415), and the processing is returned to print completion confirmation processing of print PDL, and this processing is repeated until print processing for the entire pages included in PDL data is completed.

As in the above, the accounting device according to the present embodiment calculates an estimated toner use amount in case of printing out a print job with plural image forming methods respectively whose toner amounts are different at the time of print processing, notifies image forming methods and respective accounting amounts, and makes a user select a image forming method. With the function of selecting a print method based on display of accounting amounts, image quality reflecting the object of print processing of the user and print processing in view of cost become possible.

### Eighth Embodiment

Next, the eighth embodiment according to the present invention will be explained.

The eighth embodiment is a variation of the seventh embodiment, which enables accounting amount notification on the page basis, and image forming method selection.

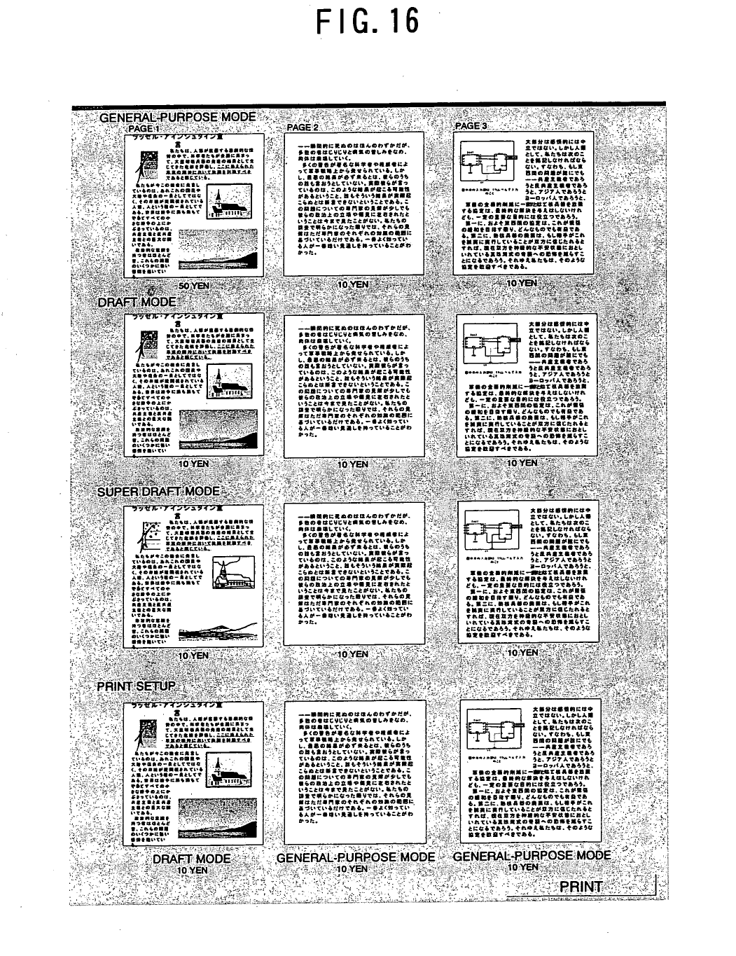

The accounting device according to the present embodiment retains accounting amounts on the page basis in respective image forming methods in the data storage unit 104 in accounting amount calculation processing of respective image forming methods in the seventh embodiment, notifies the accounting amounts to the user, and can receive and process designation information of image forming method on the page basis selected by the user in the processing of receiving image forming method selection result. Then, in the processing of forming image to be printed out, an image is formed using an intermediate code generated by an image forming method designated by the page based on the received image forming method selection result on the page basis. FIG. 16 is an example of image display on a display unit, not shown, of accounting amount notification and image forming method selection of the present embodiment. As image forming methods, there are three kinds of modes or the general-purpose mode, draft mode, and super draft mode, and the accounting amount calculation unit displays accounting amounts imposed at the time of printing out print data under thumbnail images of the respective print modes.

The user selects one image forming method from three kinds on the page basis by clicking a thumbnail image thereof. The setup by the user is stored in the setup information storage unit 105, and the contents are displayed on a print setup part located under a screen, and an image forming method for each page selected by the user and its accounting amount are displayed. At the stage when the screen is initially displayed, the image forming method is displayed on the print setup part with the default setup of a printer selected.

### Ninth Embodiment

Next, the ninth embodiment according to the present invention will be explained.

The present embodiment is a variation of the eighth embodiment, which enables accounting amount display on the page basis and image forming method selection on the object basis. Hereinafter, parts similar to those of the above-described embodiments are indicated with the same reference numerals, and detailed explanation of which will be omitted.

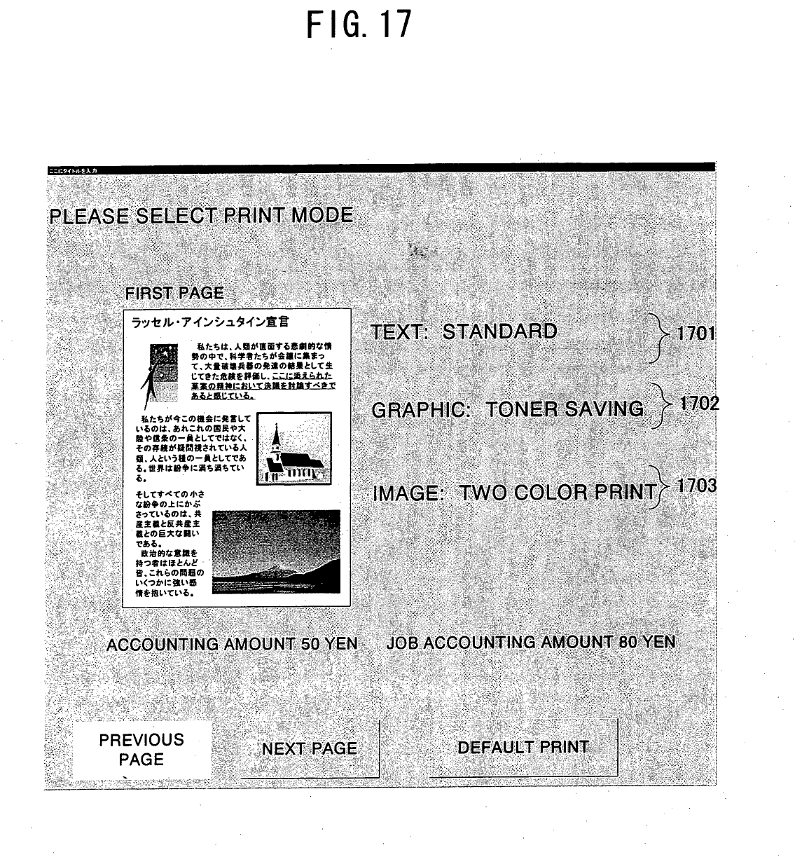

FIG. 17 is a diagram showing the image forming processing method selection and accounting amount display on the object basis using a UI of the present embodiment. The user can specify an image forming method for each object kind such as text, graphic, and image on the page basis with an accounting amount being confirmed through the interface. The setup of image forming processing for respective objects is performed at a selection item 1701, a selection item 1702, and a selection item 1703 which are the selection portion on the UI. When clicking the portion where the setup of respective objects is displayed, a list of image forming methods which can be set up for subject objects is displayed on a pull-down menu or the like. The user selects an image forming method that fits in well with the object of print processing of the user from the list. In case of printing out data for the purpose of elaboration, since character part alone is required to be corrected, it is required that image part is printed out with a level under which picture part is identified. In this case, the image part can be printed out with less toner consumption amount by two color print processing or the like.

In the user interface shown in FIG. 17, display of thumbnail images, an accounting amount of a page, and a job accounting amount are updated in the manner of reflecting the change of setup carried out by the user. As for the update of thumbnail images, thumbnail images of a page, area information of respective objects in thumbnail images, an estimated color toner consumption value of respective objects in print processing are transmitted at the same timing as the notification of an accounting amount of a page, while as for calculation of an accounting amount, an estimated color toner consumption value received prior to display is multiplied by a coefficient corresponding to an image forming method to be summed up. On the other hand, as for the update of thumbnail images, area information of respective objects is used, and processing corresponds to a setup image forming method is applied to pixel values of thumbnail images.

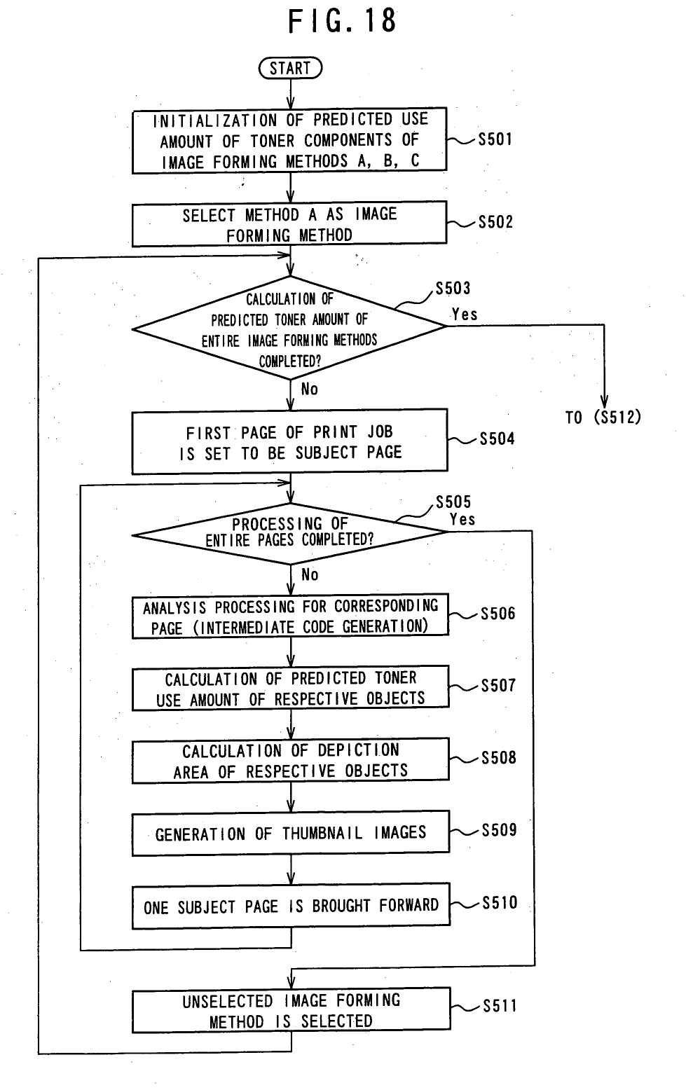

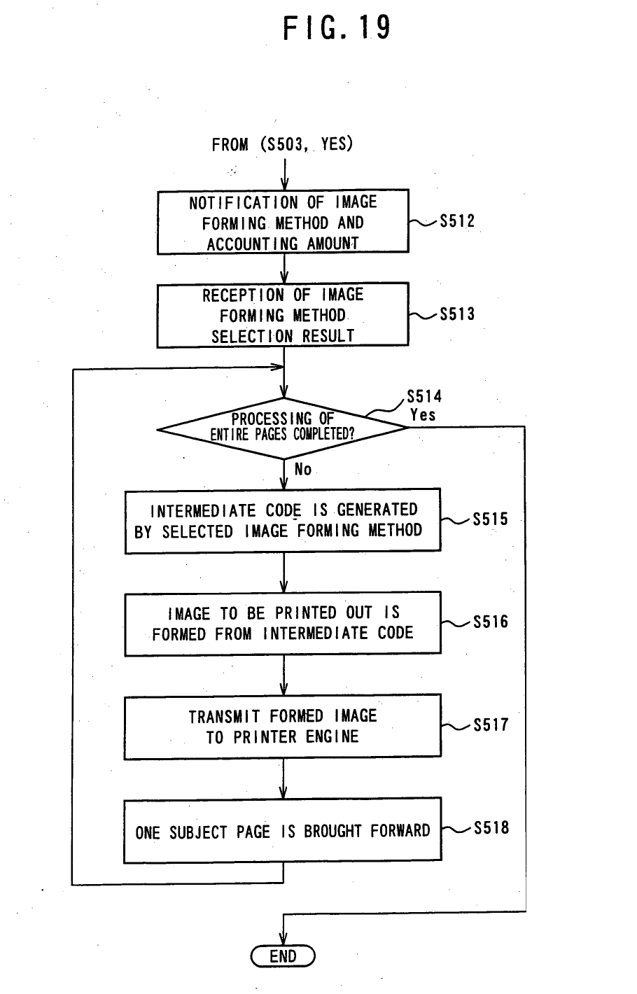

Next, using flow charts, the flow of the processing of the present embodiment will be explained (FIG. 18 and FIG. 19).

Firstly, after receiving PDL data, an area in which accounting amounts of a plurality of image forming methods owned by a subject image forming apparatus are to be saved is initialized (S501). In this case, it is assumed that three kinds of forming methods whose accounting amounts are different are owned. Next, one image forming method is selected so that an intermediate code can be generated from the image forming method (S502).

With respect to all the three image forming methods, in order to repeat a series of undermentioned processing to calculate a value necessary in calculating an accounting amount, it is judged whether or not the calculation is completed concerning all the image forming methods (S503). In case the processing is completed (S503, Yes), the processing goes on from the notification processing to the user to the print processing, while in case not (S503, No), the following processing will be carried out. So as to repeat a series of undermentioned processing necessary in calculating an accounting amount from the first page to the last page included in PDL data, the subject page to be processed is set to be the first page (S504).

In this processing, it is judged whether or not a page during processing exceeds the last page of PDL data (S505). In case the page exceeds the last page (S505, Yes), it is meant that processing for the entire pages of PDL data is completed, while in case not (S505, No), it is meant that processing for the pages is in midstream. In case the processing is not completed, analysis processing is performed for the page by employing the set up image forming method to generate an intermediate code (S506), and a text object, a graphic object, and an estimated toner use amount for each image object being print components are calculated using thus calculated intermediate code (S507), then a depiction area is calculated (S508).

Then, thumbnail images are generated from the intermediate code (S509), one page of subject pages is brought forward (S510), and the processing is returned to the entire page processing completion judgment to repeat the serial processing for the entire page. The above-described processing is repeated, and after the processing for the entire pages is completed, an unselected image forming processing is selected (S511). And the processing is returned to the completion judgment processing concerning all image forming methods.

When the serial processing concerning accounting amount determination is completed with respect to all the image forming methods (S503, Yes). Next, thumbnail images formed by respective image forming methods, estimated toner use values of respective objects, and a depiction area is notified to a PC of the user who will perform print processing (S512).

The PC that is communicably connected to the accounting device of the present invention configures a UI based on thus received information, and displays a thumbnail which confirms the effect in case the accounting amount and object is changed, and makes the user select an image forming method on the object basis (refer to FIG. 17). Then, the PC obtains contents of print setup which is set up by the user (S513), and transmits information to a printer engine so that print processing is performed by employing an image forming method of print setup received through a series of undermentioned processing (S517).

At first, it is judged whether or not the page exceeds the last page to judge whether or not processing for the entire pages is completed (S514). In case the processing is not completed, the page is analyzed by a selected image forming method to generate an intermediate code (S515), and an image to be printed out is formed from thus generated intermediate code (S516). Then, thus formed image to be printed out is transmitted to a printer engine to be printed out (S517), and one page of subject pages is brought forward (S518), and the processing is returned to the processing completion judgment of the last page. The serial processing is repeated for the entire pages included in a print job, and image forming processing is completed when processing for entire pages is completed.

### Tenth Embodiment

Next, the tenth embodiment according to the present invention will be explained.

In the present embodiment, the highest amount and the lowest amount of an accounting amount of a print job are notified to a user, and a desired accounting amount is accepted from the user, and an image forming method meeting the desired accounting amount is automatically selected, and print processing is carried out. Hereinafter, parts similar to those of the above-described embodiments are indicated with the same reference numerals, and detailed explanation of which will be omitted.

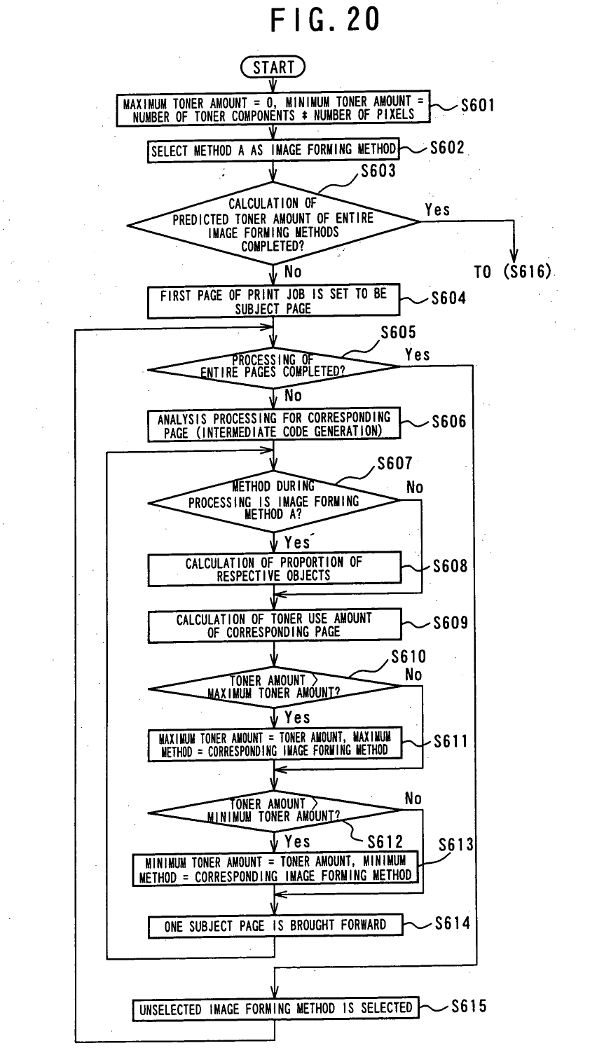

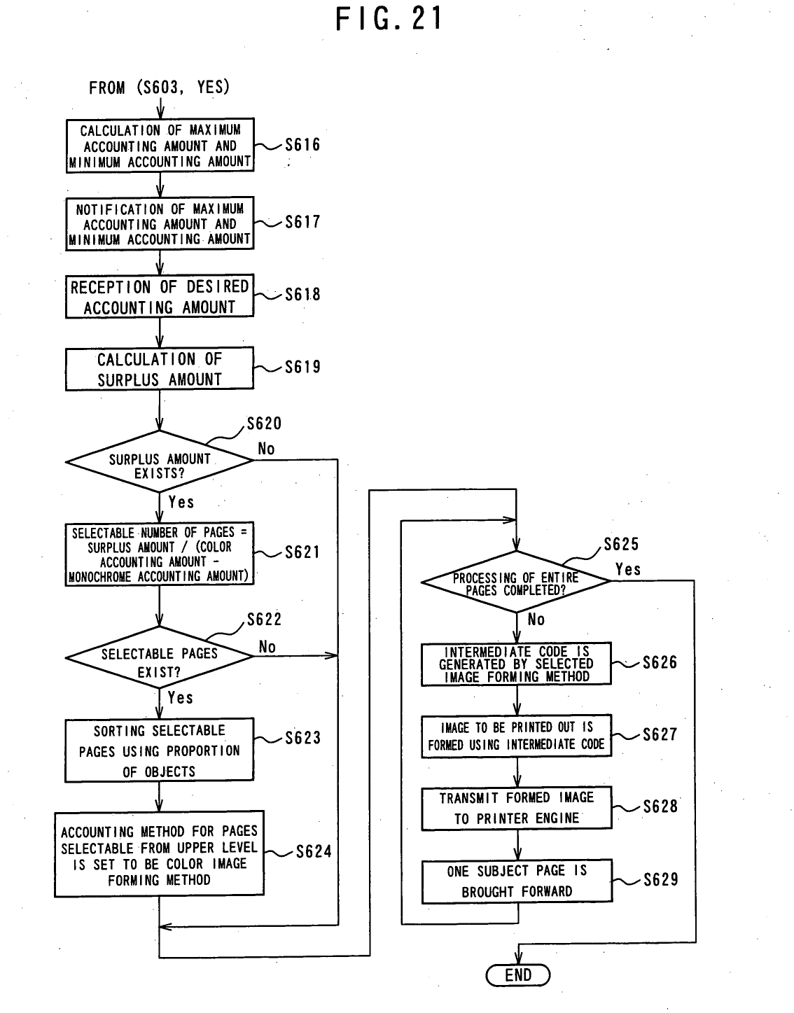

FIG. 20 and FIG. 21 are flow charts for explaining the flow of the processing in the tenth embodiment. Image forming processing is brought about after PDL data caused by print operation of the user is received, and variables retaining the highest accounting amount and the lowest accounting amount in case of performing print processing by employing a plurality of image forming methods are initialized (S601). Next, one image forming method is selected (S602).

Next, with respect to the plural image forming methods, it is judged whether or not undermentioned processing of calculating the maximum value and the minimum value of an accounting amount is completed (S603). In case processing for all the image forming methods is not completed (S603, No), undermentioned processing is performed to calculate the maximum value and the minimum value of an accounting amount. For calculating the accounting amount, the first page of PDL data is set to be the processing subject (S604), and it is judged whether or not processing for the entire pages is completed (S605). In case the processing is not completed (S605, No), PDL data is analyzed to generate an intermediate code (S606).

When image forming processing during processing accords with one particular image forming method (S607, Yes), the proportion of depiction areas of respective depiction objects is calculated by utilizing the intermediate code (S608). Next, an estimated toner use amount of a page is calculated from the intermediate code (S609). Then, in case thus calculated estimated amount exceeds the maximum value, the maximum value is overwritten, while in case the estimated amount is lower than the minimum value, the minimum value is overwritten (S610 to S613).

Then, one page of subject pages is brought forward (S614), and the processing is returned to the page processing confirmation judgment processing (S607). When the above-described processing is completed with respect to all the image forming methods, the highest amount and the lowest amount of an accounting amount is calculated in the previous processing (S616), and the user is notified of thus calculated amount (S617). The user notifies a desired accounting amount between the highest amount and the lowest amount notified from the accounting amount calculation unit of the accounting device to the accounting device. The image forming processing receives the amount (S618), and it is judged whether or not there exists a surplus which can change the image forming method with the desired amount (S619, S620).

In case it is determined that the image forming method can be changed (S620, Yes), the number of pages that can be changed is calculated (S621). Then, it is judged whether or not there exist pages which will be effective when changing an image forming method (S622). In case there exist pages which will be effective when changing an image forming method (S622, Yes), pages that can be changed are sorted using a depiction area of object assortment being the judgment standard (S623), and previously calculated pages that can be changed are selected from the upper level of the sorted pages, and these pages are set to be the subject pages of changing an image forming method (S624). After completing a series of processing to determine pages of changing an image forming method, print processing completion is judged so as to perform a series of undermentioned print processing for the entire pages (S625), and in case print processing is not completed (S625, No), an intermediate code employing an image forming method based on selection information concerning the page is generated from PDL data (S626). Then, an image to be printed out is formed in accordance with thus generated intermediate code (S627), and the formed image is transmitted to a printer engine to print out the page (S628). Then, the subject page for print processing is brought forward in order to print out the next page (S629), and the processing is returned to the print processing completion judgment processing, and the processing is completed when the print processing is completed.

### Eleventh Embodiment

Next, the eleventh embodiment according to the present invention will be explained.

The eleventh embodiment is a variation of the tenth embodiment, in which the condition of setting the priority of changing image forming methods can be specified by the user. Hereinafter, parts similar to those of the above-described embodiments are indicated with the same reference numerals, and detailed explanation of which will be omitted.

In the accounting device according to the present embodiment, the condition at the time of page selection to change image forming methods is accepted together with the desired user accounting amount input in print processing, and image forming methods and page selection of changing image forming methods are changed to carry out print processing based on the information.

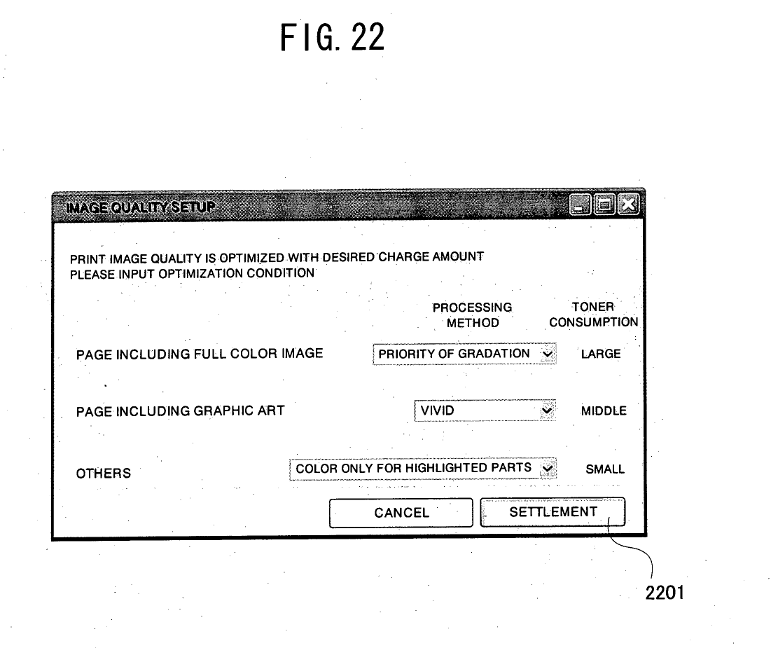

FIG. 22 is an example of a user interface for use to make the user input the priority of changing image forming methods. The interface makes the user to select image forming methods depending on objects included in a page. In the selection state shown in FIG. 22, in case a page includes a full color image, setup of selecting an image forming method in which the priority of gradation expression is given is performed. Along with image forming method selection, a rough standard of toner consumption at the time of print processing employing the method is concurrently displayed, and the user can set up the showing of materials to be printed out by judging the image quality and cost.

Furthermore, as setup contents for a page including a graphic art, an image forming method by the vivid print under which color parts are brilliantly printed out is selected, and as for pages of others that do not meet the above-described condition, setup of print processing in which color is used only for highlighted parts is performed.

After inputting conditions, when a settlement button 2201 is pressed on the UI, condition information that the user selects is transmitted to the accounting device. In the accounting device, condition judgment is performed for thus received conditions for pages in the order from low toner consumption, and pages meeting the conditions are settled.

For combination of the user selection on the UI, a printer controller (accounting device of the present embodiment) is provided with information concerning correspondence relation of weighted values for object assortment used in selecting an image forming method. Information concerning the correspondence relation is stored in the data storage unit 104. Prior to sort processing of pages in the tenth embodiment (S623), values obtained by multiplying the proportion of respective object assortments by weights corresponding to the assortments for respective pages are summed up, and the sort processing is performed using the obtained value.

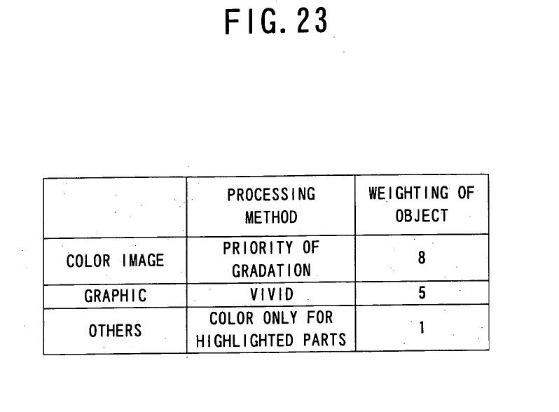

An example of printing out color documents of three pages in the system will be explained. It is assumed that unit prices of a color page and a monochrome page are 40 yen and 10 yen, respectively. In the print processing, charge amount input for print processing from 30 yen to 120 yen is requested for the user. It is assumed that the user inputs 90 yen, and the condition of image forming method is set up as shown in FIG. 23. It is assumed that the accounting amount calculation unit of the accounting device calculates proportions of depiction object of respective pages (S608), and proportions of text, graphic, and image of respective pages are (30%, 50%, 20%) for the first page, (50%, 10%, 40%) for the second page, and (20%, 0%, 80%) for the third page.

It costs 30 yen when printing out all the documents in monochrome, and unused amount of the input money becomes 60 yen, and it is calculated that color print can be possible for two pages when the unused amount is used (S621). The accounting device (printer controller) calculates comparison values of respective pages for the sorting to determine pages to be printed in color, multiplies the values calculated in S608 of FIG. 20 by weights shown in FIG. 23, and calculates the comparison values of respective pages of 440 (1*30+5*50+8*25) for the first page, 420 (1*50+5*10+8*40) for the second page, and 660 (1*20+5*0+8*80) for the third page. Using these values, the sorting of the third page, first page, second page is set up. In S624 of FIG. 20, based on the result, it is determined to print out two pages from the upper level or the first page and third page in color.

The present embodiment changes image forming methods on the object basis, which processing is performed on the page basis in the tenth embodiment. According to the embodiment, after the desired accounting amount settlement processing in print processing, the user can select an image forming method on the object basis. The accounting device 1 determines pages whose object can be changed from desired accounting amount and image forming method selection information of the user stored in the setup information storage unit 105, and changes image forming methods of an object in the determined page based on the selection information to send thus changed image forming method to a printer engine.

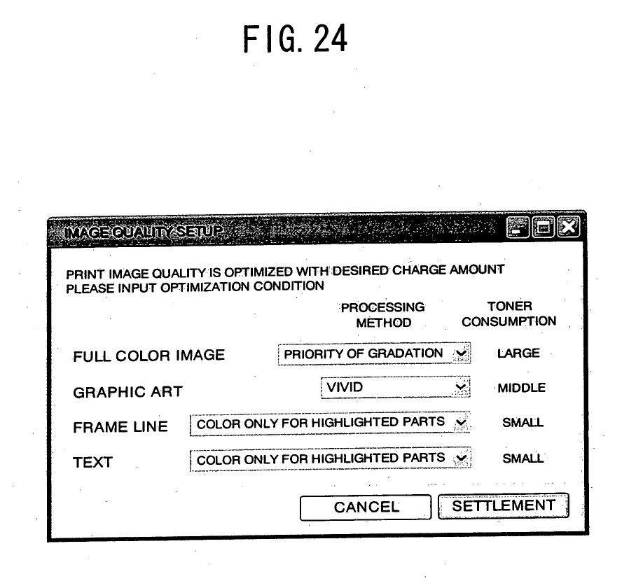

FIG. 24 is an example of a user interface for use to make the user select the image forming method for an object in a page. The user selects an image forming method for each object, and presses the settlement button after completion of selection to transmit the selection information to a printer engine.

As in the above, according to the above-described embodiments, in case of printing out documents in which color toner is used for small part, appropriate accounting judgment can be carried out under which color accounting is not imposed but monochrome accounting is imposed. Furthermore, since accounting amount is predicted based on the size of print data, predicted accounting amount can be calculated quickly. The user can make a selection within a range in which the accounting amount of a print job is determined. Moreover, after figuring out the accounting amount, the user can select the image forming method and perform print processing depending on the level of importance of documents.

Although shown implemented in a personal computer, the invention may be implemented with any computing device. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run any operating system, including, for example, variations of the Linux, Unix, MS-DOS, Microsoft Windows, Palm OS, and Apple Mac OS X operating systems.

Although the techniques discussed herein are described with regard to a compact disk, the techniques may be implemented with any storage media in any storage device included with or otherwise coupled or attached to a computing device. These storage media include, for example, magnetic media such as hard disks, floppy disks and tape; optical media such as compact disks (CD-ROM and CD-RW) and digital versatile disks (DVD and DVD±RW); flash memory cards; and any other storage media. As used herein, a storage device is a device that allows for reading and/or writing to a storage medium. Storage devices include, hard disk drives, DVD drives, flash memory devices, and others.

By data unit, it is meant a frame, cell, datagram, packet or other unit of information.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

According to the present invention, there are provided an accounting device, an accounting method, and an accounting program that can realize appropriate color accounting for the image forming processing.

It is claimed:

1. An accounting device that judges accounting for image forming processing, comprising:
a use amount estimation unit that estimates a use amount of color toner of a job which performs image forming processing; and
an accounting judgment unit that determines color accounting in case the color toner use amount estimated by the use amount estimation unit exceeds a predetermined threshold value.

2. The accounting device according to claim 1, wherein
the use amount estimation unit estimates the color toner use amount based on at least the print resolution and the number of pixels of an area which is to be depicted using color toner.

3. The accounting device according to claim 1, wherein
the use amount estimation unit estimates the color toner use amount based on a display list generated corresponding to a job of image forming processing.

4. The accounting device according to claim 1, wherein
the use amount estimation unit estimates the color toner use amount of an entire job of image forming processing.

5. The accounting device according to claim 4, wherein
the accounting judgment unit divides a color toner use amount of an entire job of image forming processing estimated in the use amount estimation unit by a predetermined toner amount corresponding to one color print page, and sets thus calculated quotient to be the number of pages subject to color accounting.

6. The accounting device according to claim 1, wherein
in case a job to be judged performs image forming processing of a plurality of pages, the accounting judgment unit determines color accounting for the job on the page basis.

7. The accounting device according to claim 1, wherein
the use amount estimation unit estimates the color toner use amount for each image forming processing when performing image forming processing of plural kinds whose accounting amounts for pages in a job of image forming processing are different, and
has an accounting amount calculation unit that calculates accounting amounts for the pages in each image forming processing based on the color toner use amount estimated in the use amount estimation unit.

8. An accounting method that judges accounting for image forming processing, comprising the steps of:
a use amount estimation that estimates a use amount of color toner of a job which performs image forming processing; and
an accounting judgment that determines color accounting in case the color toner use amount estimated by the use amount estimation step exceeds a predetermined threshold value.

9. The accounting method according to claim 8, wherein
the use amount estimation step estimates the color toner use amount based on at least the print resolution and the number of pixels of an area which is to be depicted using color toner.

10. The accounting method according to claim 8, wherein
the use amount estimation step estimates the color toner use amount based on a display list generated corresponding to a job of image forming processing.

11. The accounting method according to claim 8, wherein
the use amount estimation step estimates the color toner use amount of an entire job of image forming processing.

12. The accounting method according to claim 11, wherein
the accounting judgment step divides a color toner use amount of an entire job of image forming processing estimated in the use amount estimation step by a predetermined toner amount corresponding to one color print page, and sets thus calculated quotient to be the number of pages subject to color accounting.

13. The accounting method according to claim 8, wherein
in case a job to be judged performs image forming processing of a plurality of pages, the accounting judgment step determines color accounting for the job on the page basis.

14. An accounting program that makes a computer judge accounting for image forming processing, the accounting program making the computer perform the steps of:
a use amount estimation that estimates a use amount of color toner of a job which performs image forming processing; and
an accounting judgment that determines color accounting in case the color toner use amount estimated by the use amount estimation step exceeds a predetermined threshold value.

15. The accounting program according to claim 14, wherein
the use amount estimation step estimates the color toner use amount based on at least the print resolution and the number of pixels of an area which is to be depicted using color toner.

16. The accounting program according to claim 14, wherein
the use amount estimation step estimates the color toner use amount based on a display list generated corresponding to a job of image forming processing.

17. The accounting program according to claim 14, wherein
the use amount estimation step estimates the color toner use amount of an entire job of image forming processing.

18. The accounting program according to claim 17, wherein
the accounting judgment step divides a color toner use amount of an entire job of image forming processing estimated in the use amount estimation step by a predetermined toner amount corresponding to one color print page, and sets thus calculated quotient to be the number of pages subject to color accounting.

19. The accounting program according to claim 14, wherein
in case a job to be judged performs image forming processing of a plurality of pages, the accounting judgment step determines color accounting for the job on the page basis.

20. The accounting program according to claim 14, wherein
the use amount estimation step estimates the color toner use amount for each image forming processing when performing image forming processing of plural kinds whose accounting amounts for pages in a job of image forming processing are different, and
has an accounting amount calculation step that calculates accounting amounts for the pages in each image forming processing based on the color toner use amount estimated in the use amount estimation step.
